(19) United States
(12) Patent Application Publication
(10) Pub. No.: US 2010/0192751 A1
(43) Pub. Date: Aug. 5, 2010

(54) DEVICE TO PROMOTE THE TECHNICALLY CORRECT SPACING BETWEEN A MUSICIAN'S PALM AND THE FRET BOARD OF A GUITAR

(76) Inventor: Kelvin Nigel Pratt, Essex (GB)

Correspondence Address: GIFFORD, KRASS, SPRINKLE,ANDERSON & CITKOWSKI, P.C, PO BOX 7021, TROY, MI, 48007-7021, US

(21) Appl. No.: 12/669,405

(22) PCT Filed: Feb. 4, 2008
(86) PCT No.: PCT/GB2008/000383

§ 371 Date: Feb. 15, 2010

(30) Foreign Application Priority Data
Jul. 16, 2007 (GB) 0713854.8

(51) Int. Cl. G09B 15/06

(52) U.S. Cl. 84/465

(57) ABSTRACT

Proper guitar fretting technique can only be achieved by the player maintaining the correct spacing between the palm of the fretting hand and the lower edge of the fret board where it meets the neck of the guitar. This spacing is difficult to achieve, and teachers spend much of their time underlining the need for musicians to maintain this spacing. The Space Trainer (“the Device”) is a teaching and practice aid that has been designed to promote the technically correct hand position for both right and left handed guitar players. Specifically the Device focuses on helping the musician to form and maintain that correct spacing between the palm of the fretting hand and the fret board of the guitar.

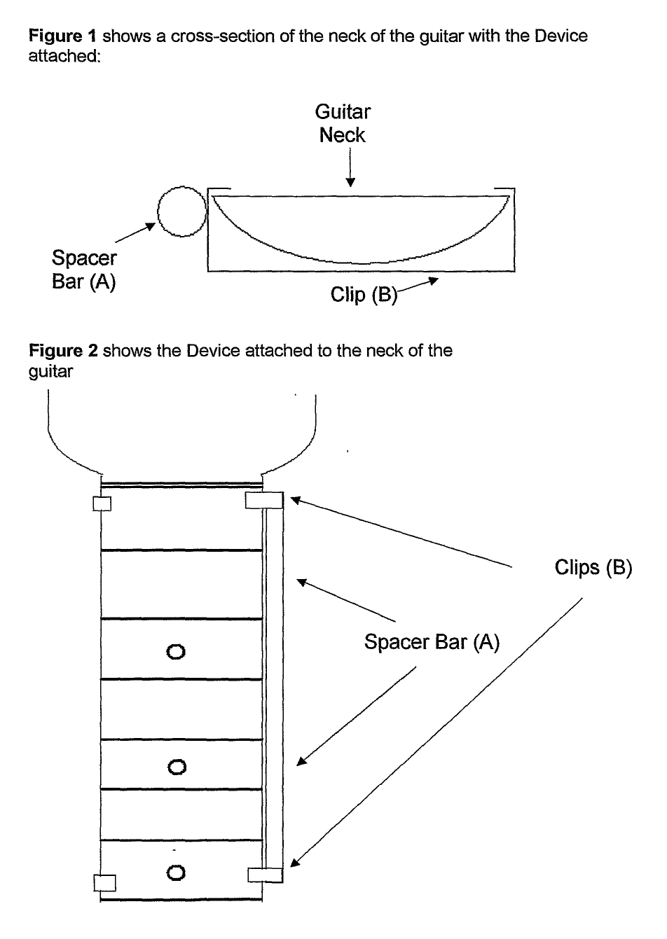

The purpose of the Device is to provide an easy to use teaching and practice aid that promotes the correct ‘arch position’ of the fretting hand.

A rod held in place by two or more clips ensures that the palm of the fretting hand is held away from the fret board as indicated by the correct fretting technique.

The rod can be of differing lengths, and the clips of differing sizes to cater for different instruments and musicians.

The clips ensure that the rod is held in place without interfering with the function of the instrument, and without damaging the instrument. The clips can be manufactured as an integral part of the Device, or as separate parts that themselves clip, or are glued, to the Spacer Bar.

The device should be manufactured in a material, such as plastic, that is rigid enough to hold the Spacer Bar firmly in place, and malleable enough to ensure that the Device does not damage the instrument.

The Device can be rotated and used on left handed instruments and could be used on other stringed instruments, such as, but not limited to, violins, violas, and cellos.

1-7. (canceled)

8. A hand position training aid for a guitar, comprising:
a spacer bar adapted to be attached along an edge of a neck of a guitar, parallel to the strings of the guitar.

9. The hand position training aid of claim 8, further comprising clips connected to the spacer bar and operating engage the neck of the guitar to retain the spacer bar in position on the neck of the guitar.

10. The hand position training aid of claim 9, wherein the clips are flexible.

11. The hand position training aid of claim 9, wherein the clips are configured to rest on a fret board of a guitar and underneath the strings of a guitar.

12. The hand position train aid of claim 9, wherein the clips are one of integral of the spacer bar or removably attached to the spacer bar.

13. The hand position training aid of claim 8, wherein the spacer bar includes a predetermined diameter.

14. The hand position train aid of claim 8, wherein the spacer bar includes a predetermined length.

15. The hand position training aid of claim 8, wherein the spacer bar includes a circular cross-section.

16. The hand position training aid of claim 8, wherein the spacer bar is configured to attach to at least one of a right edge or a left edge of a neck of a guitar.

17. The hand position training aid of claim 8, wherein the spacer bar is curved.

18. A hand position training aid for a stringed instrument, comprising:
a spacer bar and a mounting bracket, the mounting bracket operating to position the training aid on a neck of a stringed instrument so that the spacer bar is positioned along an edge of a neck of the instrument and parallel to the strings of the instrument.

19. The hand position training aid of claim 18, wherein the mounting bracket comprises a clip.

20. The hand position training aid of claim 19, wherein the clip is configured to engage each edge of the neck of the stringed instrument.

21. The hand position training aid of claim 19, wherein the spacer bar includes an elongated bar having a pair of ends and the mounting bracket includes a pair of clips with each clip being positioned along the length of the spacer bar.

22. The hand position training aid of claim 21, wherein each clip is configured to engage each edge of the neck of the stringed instrument.

23. A combination training aid and instrument, comprising:
a stringed instrument having a neck; and
a training aid including a spacer bar positioned along an edge of the neck of the stringed instrument and parallel to the strings of the stringed instrument.

24. The combination training aid and instrument of claim 23, wherein the stringed instrument is selected from a group consisting of an acoustic guitar, an electric guitar and a bass guitar.

25. The combination training aid and instrument of claim 23, wherein the training aid further comprises a mounting bracket operating to position the training aid on the neck of the stringed instrument so that spacer bar is positioned along an edge of a neck of the instrument and parallel to the strings of the instrument.

26. The combination training aid and instrument of claim 25, wherein the mounting bracket includes a clip and the spacer bar includes a circular cross-section.

27. The combination training aid and instrument of claim 23, wherein the spacer bar is curved.
